(19) United States
(12) Patent Application Publication
(10) Pub. No.: US 2008/0158002 A1
(43) Pub. Date: Jul. 3, 2008

(54) Portable object tracking system and security tracking bag or money pack for use therewith

(75) Inventors: William R. Parkinson, Thomson, GA (US); Jack Runyon, Manassas, VA (US)

Correspondence Address: SUGHRUE MION, PLLC, 2100 PENNSYLVANIA AVENUE, N.W., SUITE 800, WASHINGTON, DC, 20037, US

(73) Assignee: W.R. Parkinson Co., Inc.

(21) Appl. No.: 11/944,504

(22) Filed: Nov. 23, 2007

Related U.S. Application Data
(63) Continuation of application No. 11/111,790, filed on Apr. 22, 2005, now abandoned.

(51) Int. Cl. G08B 5/22

(52) U.S. Cl. 340/825.49

(57) ABSTRACT

A person-portable object tracking system for identifying a location of a tracked person-portable object such as a security tracking bag, money pack or other container by a location identifier powered by a portable power source, the location transmitted to a central processor by a communicator. The location identifier preferably uses the global positioning satellite system or a radio frequency identification tag. An event detector sends a signal by way of the communicator to the central processor, the signal indicating the occurrence of a predetermined event such as a change from darkness to light, movement of a handle or the like and/or opening of an enclosure, cutting, motion and/or exceeding a distance from a desired location. Using plural event detectors in logical AND combination prevents unwanted event indications. The central processor archives a history of locations of the tracked person-portable object. An embodiment further includes a wireless local network with a cluster of tracked person-portable objects and a local communicator.

### BACKGROUND OF THE INVENTION

1. Field of the Invention

The present invention relates to a system for tracking the location and/or other status of a portable object, particularly a portable object that can be hand carried by a person with or without the assistance of a mechanical device (herein a “person-portable object”), such as a security tracking bag or security crate that may be carried by hand or moved with a dolly, cart or hand truck. The invention also relates to a security tracking container or bag for use in such a system. The further present invention relates to a wireless system capable of identifying the geographic location of an asset tag associated with a tracked person-portable object based upon a signal sent by the asset tag in response to an input signal for polling or indicating the occurrence of a predetermined event detected by an event detector, and a security tracking bag for use therewith.

2. Description of the Related Art

There are a variety of areas wherein a need exists for a system capable of identifying and/or tracking the geographic location of a remote person-portable object. For example, many business operations transport valuable person-portable objects from one location to another during the routine practice of the business operation. Some such business operations use armored cars, trucks and airplanes to transport money, securities, and other valuables such as jewelry, pharmaceuticals, and electronic components. Insurance rates for such transported valuables are extremely high. When valuables are transported on a regular basis in the conduct of a business, these high insurance rates are compounded. Thus, there exists an enormous commercial need for a person-portable object tracking system capable of tracking the location of valuables during transit.

When merchants and banks procure services to transport cash money, securities, and/or other valuables from one location to another, it is common for the service provider to utilize a specialized security tracking transport bag in the process. Such a bag is also sometimes referred to as a money bag, a bank bag, or a bank money bag. A fire resistant version of such a bag is described in U.S. Pat. No. 5,056,603, issued to William R. Parkinson on Oct. 15, 1991.

Occasionally transported valuables are lost or stolen prior to, during, or after, transport from one location to another. When loss or theft of valuables occurs, there exists a strong desire to recover those lost or stolen person-portable objects. Thus, there exists a need for a system capable of tracking the location of a lost or otherwise valuable or important object that may comprise or be within a person portable object.

Systems have been implemented in automobiles, which are too large to be considered a “person-portable object,” and utilized by police and insurance companies to recover lost or stolen vehicles, which have battery recharging systems. However, systems currently utilized in connection with automobiles are far too bulky and heavy, and require far too much power, to be practically and effectively implemented in connection with smaller objects, particularly person-portable objects. Thus, there exists a need for a person-portable object tracking system capable of practical and effective implementation in connection with a relatively small tracked person-portable object.

Well known global positioning satellite (GPS) systems are used to identify the geographic location of a GPS sensor. However, these known GPS systems require a substantial draw on power and a significant passage of time prior to producing an accurate positional reading. More recently, technology has been developed, for example, by SnapTrack, Inc., that is capable of using the GPS network in a manner that provides positional information much more quickly, with much less of a draw on power than previously known GPS systems, and with much better penetration of buildings and other structures such as dumpsters and moving vehicles. Such technology may be necessary or desirable for the practical and effective implementation of a person-portable object tracking system capable of tracking the location of a relatively small tracked person-portable object, such as a person-portable object. Thus, a need exists for a person-portable object tracking system capable of quickly acquiring a GPS positional reading of the position of a GPS sensor in a wide range of locations with a minimal usage of power.

Just as with car owners, homeowners also have a desire to recover lost or stolen household items having significant value. Thus, there exists a need for a person-portable object tracking system capable of tracking lost or stolen household items that are valuable.

Ideally, such a system would be capable of tracking the location of a person-portable object without limitation or constraint. As technology develops, such a system may become possible. However, practical considerations generally limit the extent to which a missing person-portable object may be tracked. Nevertheless, several emerging technologies present the possibility of significantly increasing the extent to which a lost person-portable object may be tracked. More particularly, various wireless technologies increase the bounds of how, when and where a person-portable object is tracked. Thus, there exists a need for a person-portable object tracking system that utilizes wireless technology.

In order to remotely detect the location of an object through the use of wireless technology, generally a transmitter is used that transmits a signal, which may have any of a variety of forms, to a remote signal receiver. Alternatively, the transmitter may possess a property or characteristic capable of detection by a remote sensor, or both. However, many valuable person-portable objects such as jewels, currency and securities, even when packaged together, are quite small and cannot have a large transmitter. Likewise, some transmitters are removed from use or circulation as they grow old. Further, particularly in the case of a signal transmitter, temporary or permanent replacement may be necessary due to failure or for maintenance.

For the foregoing reasons, it may be impractical or undesirable to include a signal transmitter or an inherent characteristic as an embedded part of the actual person-portable object to be tracked. Thus, there exists a need for an asset tag or some other sort of removable attachment associated with a person-portable object to be tracked, the asset tag capable of transmitting a signal or possessing an inherent characteristic capable of remote detection.

On the other hand, particularly in the case of theft, it may be undesirable for an asset tag associated with a tracked per to be readily apparent and easily removed. When an asset tag associated with a tracked person-portable object is readily apparent and easily removed, a thief might easily remove the asset tag and thus thwart a purpose of the person-portable object tracking system in which the stolen person-portable object and associated asset tag were a part. Thus, there exists a need for an asset tag associated with a tracked person-portable object in an person-portable object tracking system wherein the asset tag is concealed and not readily apparent to a person handling the person-portable object, absent foreknowledge of the existence and location of the asset tag.

When a transmitted signal is used to identify the location of a person-portable object in a person-portable object tracking system, it is generally necessary for a signal transmitter to benefit from some sort of power source. Where the tracked person-portable objects are self contained person-portable objects, the power source for a location transmitter in such self-contained person-portable object is typically a battery having a limited supply of power. While the battery may be contained in a charging system, such as a solar cell charging system, typically the person-portable object is not subject to a reliable source of light. Thus, it is desirable for a location transmitter in a person-portable object tracking system to discontinuously transmit a location identifying signal. Further, it is envisioned that technologically sophisticated thieves may utilized a variety of transmitted signal detectors to recognize the existence and location of a signal transmitter in a tracked person-portable object so as to prevent the proper operation thereof in an person-portable object tracking system. Thus, it is desirable for a remote operator of a person-portable object tracking system to control and limit the occasions when a signal transmitter in a tracked person-portable object transmits a location identifying signal. For these reasons, there exists a need for a transmitter in a person-portable object tracking system that transmits a location identifying signal in response to an input polling signal.

Alternatively, or additionally, several prospective occurrences may be deemed to always indicate a need to identify the location of a tracked person-portable object. For example, an operator or system administrator may determine that an impact above a predetermined threshold would only occur if the tracked person-portable object fell off a truck or the truck was in a serious vehicular accident. Similarly, an operator may determine that, in certain situations, motion or exposure to light indicate a need to identify the location of a tracked person-portable object. For example, opening a security bag during transit from one location to another, or unauthorized removal of a die cut money pack from a bank vault or a bank teller's drawer, may be deemed to only occur in the case of loss or theft. Likewise, it may be believed that a money bag would not be cut except in the case of loss or theft of the tracked contents therein.

In the case of motion, it may be desirable in certain applications that some motions, but not all motions, indicate a need to identify the location of a tracked person-portable object. For example, security bags transported from one location to another in an armored vehicle are ordinarily in motion along with their transport vehicle, and some jostling or movement of the bags within the transport vehicle would be expected along most travel routes. Thus, an absolute motion sensor may not be desirable for such a security bag. However, a tracking system administrator may determine that handles attached to the sides of the security bag would not move from a down position to an up position during transit unless the bag was lost or stolen, or the transport vehicle was involved in serious accident.

Security bags typically have a zipper enclosure at a top portion thereof. As an alternative, or in addition, to using a light sensor to identify the opening of the bag, it may also be desirable to identify the opening of a security bag enclosure by way of a switch or other sensor associated with the enclosure.

Often, tracked person-portable objects are transported from one location to another in groups. For example, an armored car often transports several security bags at once. Under such circumstances, it is desirable to keep all of the tracked person-portable objects together in a preferred location such as a storage area in an armored car. When one of the tracked person-portable objects is removed from the others in a predetermined proximity with its preferred location, it may be desirable to have the occurrence of this event detected and indicated.

For the foregoing reasons, there exists a need for an person-portable tracking system including an event detector capable of detecting an event such as motion, exposure to light, cutting open a security bag, heavy impact, moving the handles of a security bag from a down position to an up position, opening an enclosure of the bag such as a zipper, undesirable orientation, unexpected environmental conditions, or removing a tracked person-portable object from a predetermined proximity with a safe tag indicating a preferred location of the tracked person-portable object.

Many of the foregoing events routinely occur at certain times, such as before and after transport, without generally indicating loss or theft. For example, the interior of a bank money bag is exposed to light and its enclosure is opened when the contents of the bag are inserted prior to transport and removed after transport. Likewise, the handles of the bag are raised to carry and place the bag in the transport vehicle prior to transport and to remove the bag from the transport vehicle at the conclusion of transport. Therefore, a need exists for a person-portable object tracking system including an event detector, wherein the event detector may be activated and deactivated by a system operator.

As has been described, certain event detectors may be susceptible to giving an event indication under conditions where an event indication is unwanted, a false positive result. Moreover, it is desirable to provide an adaptability of the event detector to variable conditions so that the events that result in positive indications are selectively implemented. Thus, it is desirable to provide an event detector to a person-portable object tracking system with reduced false positive indications. This can be accomplished by combining two or more event detectors using programmable or pre-programmed logic. The logic can be implemented using a micro controller. Thus, there is a need for an person-portable object tracking system having plural event detectors connected by logic, for example AND logic. Similarly, there is a need for an person-portable object tracking system having plural event detectors connected to a micro controller using logic to process output signals from the event detectors.

Returning again to the situation where a thief attempts to thwart or overcome an event detector in a tracked person-portable object, such a person might be tricked to falsely conclude that event detection within the tracked person-portable object is successfully disengaged by equipping the tracked person-portable object with a decoy event detector more readily apparent than a real event detector contained therein. Thus, a need exists for a tracked person-portable object having a concealed event detector and a more apparent decoy event detector.

Not only is there a need for detecting individual, extraordinary events as already disclosed, there also is a need for tracking the location and/or condition of an object during transit. For example, organizations employing persons to transport person-portable objects from one location to another may suffer inefficient performance of this task and suspect unauthorized stops or diversions as a cause of the inefficiency. Furthermore, most currently known tracking technologies experience significant limitations when attempting to track the location of a person-portable object indoors. For these or other reasons, it is desirable to track the whereabouts of person-portable objects in transit. Thus, a need exists for a person-portable object tracking system wherein a central processor archives a history of locations of a tracked person-portable object.

### SUMMARY OF THE INVENTION

The present invention overcomes the above-mentioned problems associated with implementing a person-portable object tracking system that achieves the identified exemplary objectives and many others as well, by providing a person-portable object tracking system wherein a location of a transportable tracked person-portable object, such as a security tracking bag or die cut money pack, is identified by a tracking means or location identifier powered by a portable power source and transmitted to a central processor by a communication means being a long haul communicator such as a cellular band device, a paging band device or similar wireless tracking device.

According to one aspect of the inventive person-portable object tracking system, the tracking means uses the global positioning satellite system. In another aspect of the inventive person-portable object tracking system, the tracking means includes a radio frequency identification (RFID) tag or a more powerful RF transmitter.

According to yet another aspect of the inventive person-portable object tracking system, the tracked person-portable object includes an event detector for detecting a predetermined event and sending a signal by way of the communication means to the central processor, the signal indicating the occurrence of one or more specified events. Various event detectors according to this aspect of the invention include a photocell for detecting a change from darkness to light, a sensor for detecting movement of a handle or the like and/or opening of an enclosure, a smart fiber for detecting a cutting, a motion sensor for detecting motion, and other similar sensors for detecting an undesirable orientation of the tracked person-portable object and/or unexpected environmental conditions.

According to a yet further aspect of the present invention, designed to minimize false positives, certain event detectors are used in logical combination with certain others according to programmed or programmable logic, such as AND logic, to indicate a detected event.

Similarly, according to a related aspect of the present invention, a micro controller uses logic to process output signals from event detectors.

According to still yet another aspect of the inventive person-portable object tracking system, the central processor archives a history of locations of the tracked person-portable object.

According to another aspect, the person-portable object tracking system of the present invention includes a wireless local network with a cluster of tracked person-portable objects, a local communicator powered by a power source, a central local communicator for receiving local signals from the local communicators and thereby identifying the tracked person-portable objects, a central processor for identifying where the tracked person-portable objects and the central local communicator are located, and a communication means for communicating those locations to the central processor.

The present invention overcomes the above-mentioned problems associated with implementing a security tracking bag by providing a security tracking bag with a bottom, a side, and an asset tag in either the bottom or the side capable of remotely identifying its location.

According to one aspect of the security tracking bag of the present invention, the bottom includes a foam portion defining a compartment that conceals the asset tag.

According to another aspect of the security tracking bag of the present invention, the asset tag is contained in the side by a sleeve.

According to yet another aspect of the security tracking bag of the present invention, the asset tag is contained in the side by a pocket removably attached to the side by hook and loop fasteners.

According to still yet another aspect of the security tracking bag of the present invention, the asset tag is contained in the side by a pocket permanently sewn to the side.

According to a further aspect of the security tracking bag of the present invention, the asset tag is contained in the side by a pocket permanently hot glued to the side.

According to an even further aspect of the security tracking bag of the present invention, a decoy asset tag is added to distract attention from the operational asset tag.

The present invention further overcomes the above-mentioned problems associated with implementing a security tracking bag by providing a person-portable object in the form of a tracking money pack that has an asset tag or other wireless tracking device hidden within the money pack and being capable of remotely identifying its location.

According to one aspect of the security tracking feature of the present invention, a pack of real or fake money is prepared, for example by die cutting, with a hollowed cavity that is adapted to receive an asset tag or other wireless tracking device.

According to another aspect of the security tracking feature of the present invention, a pack of real or fake money is prepared with a tag or device being either on continuously or being turned on automatically or manually when delivered to a thief, or when otherwise actuated for tracking purposes.

Accordingly, the principal person-portable object of the present invention is to remotely track the location of a portable person-portable object such as a security tracking bag or tracking money pack, particularly when such an person-portable object is lost or stolen, so as to recover the lost or stolen person-portable object.

A related person-portable object of the present invention is to track the location of a person-portable object using a wireless system.

Another related person-portable object of the present invention is to track the location of a missing household person-portable object.

A further related person-portable object of the present invention is to practically and effectively track the location of a relatively small tracked person-portable object.

A still further related person-portable object of the present invention is to quickly acquire a GPS positional reading with a minimal usage of power.

Another person-portable object of the present invention is to track the location of a person-portable object through the use of an asset tag accompanying the person-portable object.

Yet another related person-portable object of the present invention is to track the location of a person-portable object through the use of a concealed asset tag.

A further person-portable object of the present invention is to identify the location of a person-portable object only in response to an input polling signal.

A still further person-portable object of the present invention is to identify the location of a person-portable object upon receiving an event indicating signal triggered by an event detector in response to a predetermined event or combination of predetermined events.

More specifically, a person-portable object of the present invention is to identify the location of a person-portable object upon receiving an event indicating signal triggered by a photocell for detecting a change from darkness to light.

Another specific person-portable object of the present invention is to identify the location of an person-portable object upon receiving an event indicating signal triggered by a sensor(s) for detecting movement of a handle or the like and/or opening of an enclosure.

Yet another specific person-portable object of the present invention is to identify the location of an person-portable object upon receiving an event indicating signal triggered by a, a smart fiber for detecting a cutting.

Still yet another specific person-portable object of the present invention is to identify the location of a person-portable object upon receiving an event indicating signal triggered by a motion sensor for detecting motion.

Even still another specific person-portable object of the present invention is to identify the location of an person-portable object upon receiving an event indicating signal triggered by an upright orientation sensor for detecting an undesirable orientation with respect to an upright position of the person-portable object.

A further specific person-portable object of the present invention is to identify the location of a person-portable object upon receiving an event indicating signal triggered by an environmental condition sensor for detecting an unexpected environmental condition in proximity with the person-portable object.

A yet further specific person-portable object of the present invention is to identify the location of a person-portable object upon receiving an event indicating signal triggered by the person-portable object being outside a predetermined proximity with a desired location.

A still further person-portable object of the present invention is to provide an event detector that may selectively be activated or deactivated within a person-portable object tracking system.

Another person-portable object of the present invention is to provide a decoy asset tag that distracts attention from a primary asset tag in a tracked person-portable object.

Yet still another person-portable object of the present invention is to provide a person-portable object tracking system wherein a central processor archives a history of locations of a tracked person-portable object.

Further person-portable objects and aspects of the invention will become apparent according to the following description.

### BRIEF DESCRIPTION OF THE DRAWINGS

These and other features, aspects, person-portable objects and advantages of the present invention will become better understood with reference to the following description, appended claims, and accompanying drawings, in which:

FIG. 1 is a schematic diagram showing a first exemplary embodiment of a person-portable object tracking system according to the present invention;

FIG. 2 is a schematic diagram showing a second exemplary embodiment of a person-portable object tracking system according to the present invention;

FIG. 3 is a schematic diagram showing a third exemplary embodiment of an person-portable object tracking system according to the present invention; and

FIG. 4 is a fragmented perspective view of an exemplary embodiment of a security tracking bag according to the present invention.

FIG. 5 is a schematic diagram of a comprehensive processor-based system that can provide one or more of a wide variety of sensing and alarm functions for a bank bag, in accordance with the present invention.

FIG. 6 is a perspective view of an exemplary embodiment of a tracking money pack, which has been die cut to receive a tracking device, in accordance with the present invention.

FIG. 7 is a schematic illustration of the flexible circuit board that would be used in connection with a tracking money pack or bank bag, in accordance with the present invention.

FIG. 8 is a flow chart detailing the steps that would be followed in implementing a tracking process according to the present invention.

### DETAILED DESCRIPTION OF THE EMBODIMENTS

The present invention is directed to a system for tracking the location of a person-portable object. More specifically, the present invention relates to a wireless system capable of identifying the geographic location of an asset tag associated with a tracked person-portable object based upon a signal sent by the asset tag in response to an input signal for polling or indicating the occurrence of a predetermined event detected by an event detector. The geographic location of a tracked person-portable object will be referred to herein interchangeably as a location or a position.

While the present invention is applicable to a system for tracking any person-portable object, an exemplary application of the tracking system wherein the tracked person-portable object is a security bag will be the focus of one exemplary embodiment for purposes of providing an enabling disclosure, written description and best mode for the present invention.

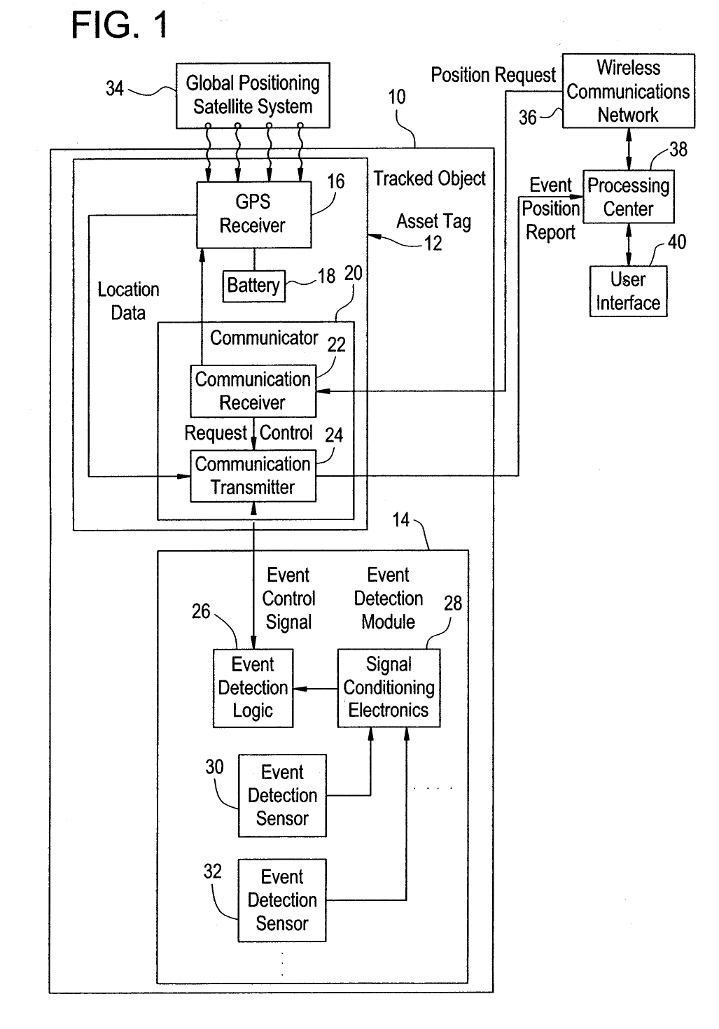

Referring to FIG. 1, there is shown a schematic diagram of a first exemplary embodiment of a person-portable object tracking system according to the present invention. In this exemplary embodiment of a person-portable object tracking system, a tracked person-portable object 10 includes an asset tag 12 and an event detection module 14. The asset tag 12 includes a GPS receiver 16, a battery 18, and a long haul communicator 20. The long haul communicator 20 includes a long haul communication receiver 22 and a long haul communication transmitter 24. The event detection module 14 includes an event detection logic 26, signal conditioning electronics 28, and, in this exemplary embodiment, event detection sensors 30, 32.

At present, it is exemplary that the long haul communicator 20 is a cellular device, such as the Sendum Asset Tracker AT 100-C provided by Sendum Wireless Corporation, a pager device, or other wireless tracking device. Specifically, it has become preferable for the long haul communicator 20 to be a cellular-based transceiver, a wireless LAN, a freenet, or some combination of these communication mediums such as a freenet with cellular telephone. It is anticipated that further technological developments in the future will determine which of these, or some other unspecified alternative, becomes the most preferable format for the long haul communicator 20.

It is presumed that the tracked person-portable object 10 is a portable person-portable object transportable from one location to another. As will be described in greater detail with respect to the exemplary security bag and money pack, in various embodiments, the asset tag 12 is associated with the tracked person-portable object 10 in various manners depending on its anticipated use or uses.

The GPS receiver 16 receives signals from satellites in global positioning satellite system 34. These signals are processed to identify the geographic location of the GPS receiver 16 according to well known GPS technology. The GPS receiver 16 is powered by the battery 18. In order to implement the person-portable object tracking system of the present invention in the widest variety of tracked person-portable objects 10, including small tracked person-portable objects 10 and light weight tracked person-portable objects 10, it is desirable that the battery 18 be as small as possible and as light weight as possible. It is believed that a variety of known rechargeable batteries are preferred. However, reducing the size and weight of the battery 18 also generally results in a reduction of the useful life of the battery 18. Therefore, it is desirable that the asset tag 12 operate in such a manner so as to conserve the consumption of power from the battery 18 by the GPS receiver 16.

For the foregoing reasons, it is desirable that the GPS receiver 16 operate intermittently. Preferably, the GPS receiver 16 only determines the location of the asset tag 12, and thus the position of the tracked person-portable object 10, at desired times. Examples of such uses of the GPS system 34 include certain U.S. patents licensed to SnapTrack, Inc., or some other network assisted technology. This technology not only lengthens the useful life of the battery 18, it also enables greater resolution of the location information and quicker acquisition of the location information.

It is believed that GPS technology is currently the best available means of identifying the location of the tracked person-portable object 10. One such technology is the Qualcomm gpsOneA™ product for providing location service with high accuracy. However, other means of identifying the location of the tracked person-portable object would function within the intended scope of the invention. Thus, in another embodiment, the GPS receiver 16 and GPS system 34 are replaced with the components of a time-delay radio system for identifying the location of the tracked person-portable object 10 using multiple radio signals according to known methods. Similarly, in still another embodiment of the present invention, a cellular network such as a cellular telephone network is used to identify the location of the tracked person-portable object 10. Even further, in yet another embodiment, radio frequency identification (RFID) is utilized as the means of identifying the location of the tracked person-portable object 10. Further, it is conceived that other means of identifying the location of the tracked person-portable object 10 will be developed and improved in the future, perhaps surpassing the above mentioned means as being the most practical, economical or efficient. For example, small inexpensive RF receivers may be placed in the object 10, so that when a searcher gets within 60-100 ft of the object, even in impaired environments such as indoors, dumpster, the RF receiver with the aid of the hand held wand can pinpoint exactly the location of asset.

Even still further, contemplated variations on a GPS system include a GPS tracker that utilizes code division multiple access (CDMA) short messaging system (SMS) e-mails to identify the location of the tracked person-portable object 10. It is believed that SMS is the most practical use of a cellular network because the associated e-mail can be sent and received without initiating a call, using the control channel of the cellular network. Further, at present, the cost of an SMS message is just a few cents. Currently, SMS is typically available on cell systems using the global system for mobile communications (GSM) technology. With the widespread provision of GSM by carriers, SMS will be available based on either GSM or CDMA. Still further, phones presently exist with embedded GPS, including advanced mobile phone service (AMPS) analog phones.

Cellular phone technology offers the most practical communication link at this time and their desirability for use in connection with the present invention is enhanced by the availability of E-911 location technology, which will eventually become ubiquitous in response to an FCC requirement. Once this takes place, adding a GPS receiver 16 to a cellular device will be very affordable and should have negligible impact on bulk and power consumption. Further, inexpensive alternatives for use with the present invention are contemplated involving anticipated cheap disposable phones, prepaid phones, the ability to make calls from unregistered phones whereby payment guaranteed. Under at least some of these alternatively contemplated scenarios, the phones will be further limited to outgoing calls only. These more affordable alternatives are not assigned phone numbers and cannot receive calls. Because there are no incoming messages, certain advantages of the present invention will be unavailable. For example, it will not be possible to externally prompt such cost cutting alternatives for a position report. Nevertheless, as will be described, even if a position report cannot be externally prompted, event detection capabilities within the tracked person-portable object 10 of the present invention will prompt an outgoing report of the location of the tracked person-portable object 10.

Any of the above-described means for identifying the location of the tracked person-portable object 10 may be incorporated within the intended scope of the present invention. These alternative means are variously represented in the Figures by the GPS receiver 16.

Upon identifying its location, the GPS receiver 16 sends location data containing that information to the long haul communication transmitter 24 within the asset tag 12. The long haul communication transmitter 24 then conveys that location information to a processing center 38 through a wireless communications network 36. In turn, the processing center 38 may store the information, process it for analysis, display and/or automated response. The processing center 38 may also convey the location of the tracked person-portable object 10 to a human user by way of a user interface 40. Thus, the long haul communicator 20 functions in the present invention as a communication means for communicating between the tracked person-portable object 10 and a central processor in the processing center 38.

For reasons described above with respect to the battery 18, it is also preferred that the means of communicating between the tracked person-portable object 10 and the processing center 38 be as small and light of weight as possible. Although this is not the sole consideration in selecting a means of communicating between the tracked person-portable object 10 and the processing center 38, cell phone technology is preferred, including cellular devices with speech chips, cellemetry systems monitoring the location of the tracked person-portable object 10 through a cellular channel, G-3 based systems, and satellite communication systems. Further to the above description, alternative embodiments of the means for communicating between the tracked person-portable object 10 and the processing center 38 include wireless modem CDPD, pagers and radio.

In the exemplary embodiment, the wireless communications network 36 utilizes network assisted GPS over the Internet. Thus, the processing center 38 is accessed by the wireless communications network 36 via the Internet. Such technology is currently in use, and improvements are in development. For example, it is believed that a two-way wireless location service is readily provided over the Internet with existing technology.

In an alternative embodiment, the wireless communications network 36 is a ricochet system of wireless communications. Examples of such systems include those using wireless communication achieved through radios permanently installed on regularly spaced fixtures such as street lights, telephone poles, or the like, which now exist or may be developed in the future. For example, another potential ricochet system is a comparable system of communication between cellular telephones wherein cell phone owners themselves become a mobile ricochet network. In yet another potential system, unlike the system using permanently installed radios for ricochet communication, individuals themselves transport small radios to form a network of ricochet communications.

Still other potential embodiments of the wireless communications network 36 include a wireless LAN, as well as the standard 802.11 and the Bluetooth wireless systems currently being implemented offer the possibility of widespread “freenets” where a population of users acts as a relay system without the need for a formal infrastructure or monthly account. An advantage of Bluetooth is that the system communicators are constantly on and looking for a response from other similarly equipped units, and when a link is found, a message is relayed via the Bluetooth freenet, rather than making a cell call. Each of the above described alternatives, or combinations thereof, represent discrete embodiments of the present invention incorporating different formats for the wireless communications network 36.

The means of communicating and transferring information and data between the wireless communications network 36 and the processing center 38 is not critical to the present invention. Any of the above described means of communicating between various other components of the invention may be utilized to communicate between the wireless communications network 36 and the processing center 38. Even a simple hard wired or land line connection between the wireless communications network 36 and the processing center 38 may be preferred depending on the specific circumstances in which the person-portable object tracking system of the present invention is implemented.

Turning now to when and why information is sent through the wireless communications network 36, in an embodiment of the present invention designed to provide the most thorough and comprehensive information regarding the location of the tracked person-portable object 10, the long haul communication transmitter 24 sends a position report through the wireless communications network 36 either continually or at regular intervals of a predetermined, relatively short length. Certain applications of the person-portable object tracking system of the present invention require precise and comprehensive location information. In these applications, it is also generally preferred that the processing center 38 store or archive the location information sent through the communications network 36. For example, an employer seeking evaluate the efficiency of an employee charged with delivering the tracked person-portable object 10 from one location to another would find a history of the location of the tracked person-portable object 10 during the course of delivery to be valuable information.

Further, the best currently available GPS system 34 has a reduced ability to identify the location of the GPS receiver 16 if the tracked person-portable object 10 is inside a transmission-interfering environment, such as a building, the trunk of a car, a dumpster. In some cases, even heavy woods impede the ability of a GPS system 34 to identify the location of the GPS receiver 16. The embodiment of the invention that provides frequent position reports for the tracked person-portable object 10 is most useful in attempting to identify the location of the tracked person-portable object 10 when its location cannot be contemporaneously identified.

However, the above described embodiment also requires the most power to function properly. Therefore, in the exemplary embodiment, the asset tag 12 is generally passive and the long haul communication transmitter 24 provides a position report only when prompted to do so. There are two discrete types of prompts that cause the passive asset tag 12 to provide a position report.

First, a position request is sent to the long haul communication receiver 22 through the wireless network 36. This position request is initiated either manually by a user through the user interface 40, or automatically according to software within the processing center 38. The communications receiver 22 may be kept on continually, programmed to listen for request signals periodically. Upon receiving a position request, the long haul communication receiver 22 cues the GPS receiver 16 to obtain a position reading.

The second type of prompt that causes the asset tag 12 to provide a position report is an event control signal or event indicator sent to the long haul communication transmitter 24 by the event detection module 14. The event prompt has an advantage over the position request prompt in that location information of a lost or stolen tracked person-portable object 10 is obtained more quickly when the event prompt is triggered at the time of the loss or theft of the tracked person-portable object 10. The event and position request prompts will be described in greater detail within.

It should be noted that the tracked person-portable object 10 might exclude the event detection module 14 in certain applications where it is preferable to do so. For example, since the event detection module 14 is primarily designed to prompt a position report from a generally passive asset tag 12, it may be considered redundant to include the event detection module 14 in above described applications seeking thorough and comprehensive location information, wherein the asset tag 12 is not generally passive.

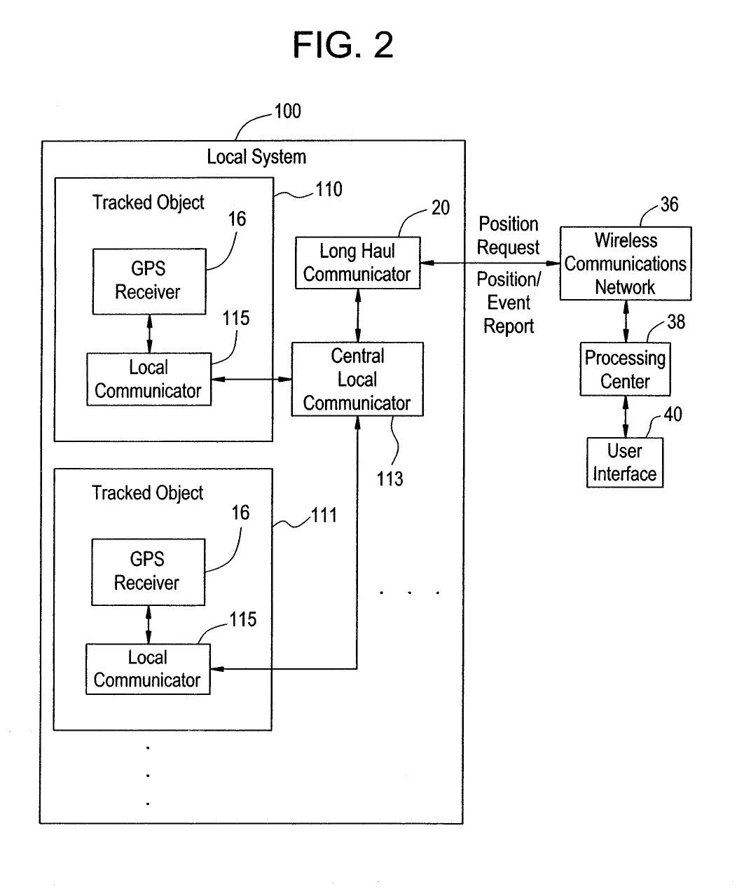

Referring now to FIG. 2, there is shown a schematic diagram of a second embodiment of a person-portable object tracking system according to the present invention. The second embodiment of the person-portable object tracking system is like the first embodiment of the person-portable object tracking system in many respects. The detailed description with reference to FIG. 2 will focus primarily on the differences between the first embodiment and the second embodiment of the person-portable object tracking system of the present invention. To the extent that reference characters are repeated in FIG. 2, those elements are the same as the corresponding element in FIG. 1, as described in detail above. Certain other elements depicted in FIG. 1 also operate in the second exemplary embodiment in the same manner as described above, but are omitted from FIG. 2 for simplicity of depiction. These elements include GPS system 34, battery 18, long haul communication receiver 22, long haul communication transmitter 24, and event detection module 14.

Of the elements in the asset tag 12 and the event detection module 14, it is believed that the most expensive item is the long haul communicator 20. For some applications, particularly applications where it is desirable to simultaneously track a large number of tracked person-portable objects 10, it may be deemed cost prohibitive to include a long haul communicator 20 with each and every tracked person-portable object 10. Consequently, in the second exemplary embodiment, a means of communicating with the processing center 38 is not included with each tracked person-portable object. This second exemplary embodiment is directed to applications wherein the person-portable object tracking system tracks a plurality of tracked person-portable objects in relatively close proximity with one another.

Thus, in the second exemplary embodiment of the present invention, a local system 100 includes a cluster of at least two tracked person-portable objects 110, 111, a central local communicator 113, and a long haul communicator 20. The long haul communicator 20 is a part of the local system 100, but not included in the tracked person-portable objects 110, 111. The clustered tracked person-portable objects 110, 111 each contain GPS receiver 16 and a local communicator 115.

The central local communicator 113 functions as a safe tag for each of the local communicators 115. If the local communicator 115 is within a predetermined distance of the central local communicator 113, then the tracked person-portable object 110, 111 is safe. If the local communicator 115 is beyond the predetermined distance from the central local communicator 113, then the tracked person-portable object 110, 111 is not safe. Therefore, the central local communicator 113 will also hereinafter be referred to interchangeably as “safe tag” 113.

Several exemplary embodiments of the safe tag 113 are provided. In these various embodiments, each local communicator 115 includes an optical or light sensor, an infrared sensor, an audio sensor or detector, an ultrasonic sensor, and/or passive and active RFID systems, or the like. Thus, the Bluetooth system may be incorporated in one embodiment of the local communicators 113, 115. Any known local or personal wireless network may be used.

In addition to the foregoing embodiments incorporating a wireless local communicator 115, yet another alternative embodiment incorporates a hard wired local communicator 115. In these various embodiments, the central local communicator 113 generates a signal or signals corresponding to the type of sensor or sensors employed in the local communicators 115, a direct signal in the case of the hard wired local communicator 115.

The signal(s) generated by the safe tag 113 have a predetermined effective range of propagation or become attenuated over a predetermined distance. Thus, by some means, the local communicators 115 are capable of identifying a condition when the tracked person-portable object 110, 111 is beyond a predetermined distance from the safe tag 113. In the case of the hard wired local communicator 115, the predetermined distance would most likely be the length of the hard wiring in the system. The continuity of the hard wire would be broken in order for the local communicator 115 to be removed from the central local communicator 113 a distance exceeding the length of the hard wire there between.

When a local communicator 115 determines that the tracked person-portable object 110, 111 is beyond the predetermined distance, the local communicator 115 requests a position report from the GPS receiver 16. In the exemplary embodiment, the GPS receiver 16 remains dormant, thus conserving power, until prompted by the local communicator 115 to provide a position report. Upon such prompting, the position of the tracked person-portable object 110, 111 is communicated to the central local communicator 113, relay from the central local communicator 113 to the long haul communicator 20, and forwarded from the long haul communicator 20 through the wireless communications network 36 and beyond as described above. Thus, information passes between the long haul communicator 20 and the wireless communications network 36 in both directions as previously described.

It is envisioned that the cluster of tracked person-portable objects 110, 111 will move from one local system to another as the tracked person-portable objects 110, 111 are in transit. For example, when bank security bags are transported from one bank or merchant to another, they are, in turn clustered at shipping points prior to loading, in courier vehicles during transit, at receiving points after unloading, and on the person of a courier during loading and unloading. Thus, a safe tag 113 is installed at each discrete location, including on the person of a courier, where the tracked person-portable objects 110, 111 are routinely clustered when safe. Since a courier of the tracked person-portable objects 110, 111 will not always be operating in the capacity of a courier, one embodiment of the safe tag 113 is designed to be detachable. Thus, the next courier may use the same safe tag 113 as a previous courier.

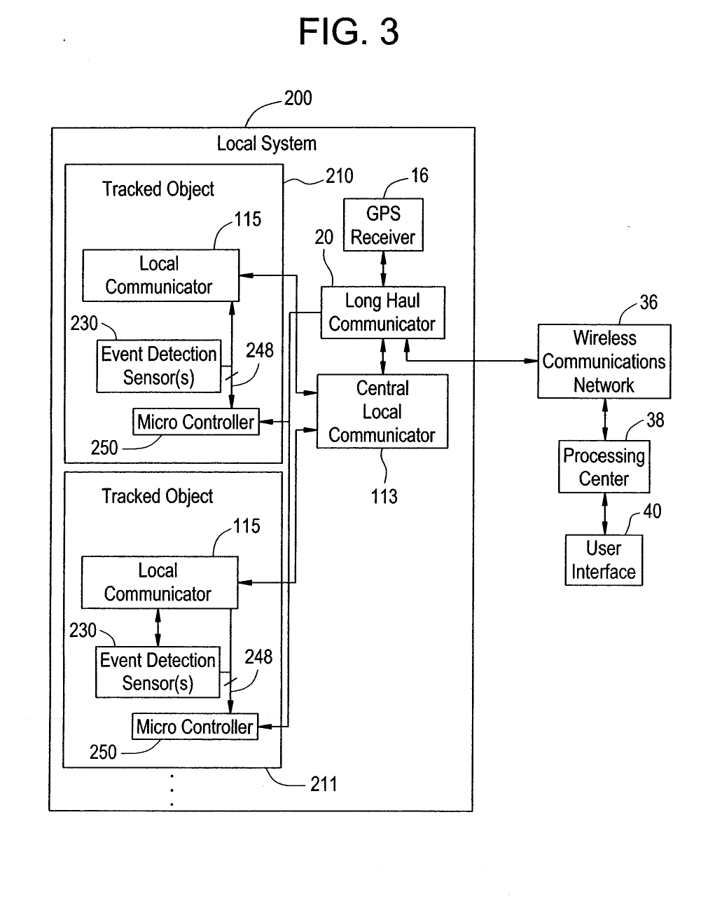

Referring now to FIG. 3, there is shown a schematic diagram of a third exemplary embodiment of a person-portable object tracking system according to the present invention. The third embodiment of the person-portable object tracking system is like the first and second embodiments of the person-portable object tracking system in many respects. The detailed description with reference to FIG. 3 will focus primarily on the differences between the third exemplary embodiment and those previously described. To the extent that reference characters are repeated in FIG. 3, those elements are the same as previously described in connection with the first and second exemplary embodiments. Certain other elements depicted in FIG. 1 operate in the third exemplary embodiment in the same manner described above, but are omitted from FIG. 3 for simplicity of depiction. These elements include GPS system 34, battery 18, long haul communication receiver 22, and long haul communication transmitter 24. The previously described two-way communication between the long haul communicator 20 and the wireless communications system 36 also occurs in the third exemplary embodiment. Additional communication occurs in the third embodiment between various elements as described below.

After the long haul communicator 20, the next most expensive item in tracked person-portable object 10 is believed to be the GPS receiver 16. The third exemplary embodiment is designed to be even less expensive than the second exemplary embodiment by also removing the GPS receiver 16 from each tracked person-portable object. This third exemplary embodiment is directed to applications wherein the person-portable object tracking system tracks a plurality of tracked person-portable objects in relatively close proximity with one another, and the degree of detail available regarding the location of a tracked person-portable object is sacrificed for the sake of lowering system costs.

Thus, in the third exemplary embodiment of the present invention, a local system 200 includes a cluster of at least two tracked person-portable objects 210, 211, a central local communicator 113, a long haul communicator 20, and a GPS Receiver 16. The long haul communicator 20 and GPS receiver 16 are a part of the local system 100, but not included within the tracked person-portable objects 210, 211. The clustered tracked person-portable objects 210, 211 each contain a local communicator 115, event detection sensor(s) 230, and a micro controller 250. The central local communicator 113 in the third exemplary embodiment functions as a safe tag for the local communicators 115 as described above.

The micro controllers 250 are designed to supplement or replace the signal conditioning electronics 28 and event detection logic 26. Although event detection was omitted from the tracked person-portable objects 110, 110 in FIG. 2 for simplicity of depiction, they may contain event detectors. Thus, the second exemplary embodiment of the person-portable object tracking system according to the present invention contains, in various forms, either the micro-controller 250 or event detection module 14 within the tracked person-portable objects 110, 111, or both. The operation of the micro controller 250 and the event detection module 14 will be described in greater detail below in connection with a security tracking bag exemplary of a tracked person-portable object in any of the foregoing embodiments of the person-portable object tracking system according to the present invention.

In order to further reduce system costs, the sacrifice made by the third exemplary embodiment of the person-portable object tracking system according to the present invention is that the location of each individual tracked person-portable object 210, 211 cannot be precisely determined unless the tracked person-portable object is in close proximity with the GPS receiver 16. Thus, a position report is prompted when the local communicator 115 within the tracked person-portable object 210, 211 exceeds the predetermined distance from the central local communicator 113, and that position report becomes the last available information regarding the location of a lost or stolen tracked person-portable object 210, 211.

Upon attempting to retrieve a lost or stolen tracked person-portable object 210, 211, it may be relatively easy to recover the tracked person-portable object 210, 211 if the tracked person-portable object 210, 211 has not moved a significant distance after becoming lost or stolen. On the other hand, in this third embodiment, it may be more difficult to recover a lost or stolen person-portable object that has been subsequently moved after leaving the local system 200. Nevertheless, since this third exemplary embodiment of the person-portable object tracking system is the most cost effective, it is believed that it is preferable for certain applications.

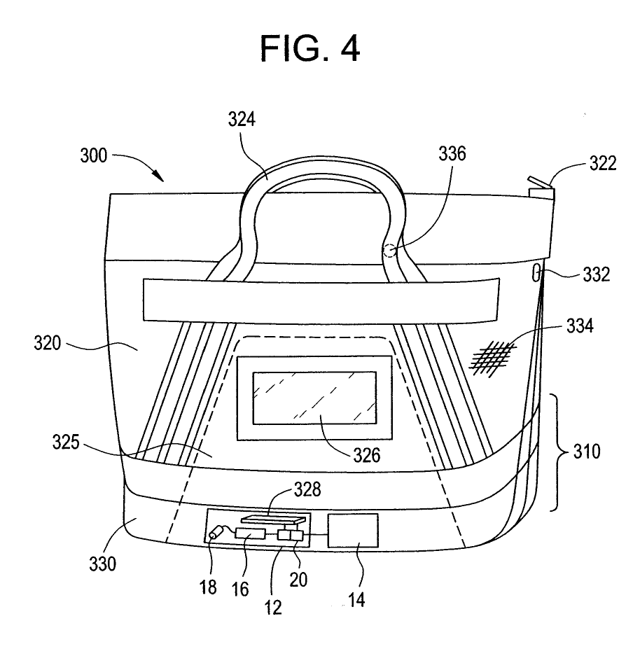

Referring now to FIG. 4, there is shown in a fragmented perspective view an exemplary embodiment of a security tracking bag 300 according to the present invention. The security tracking bag 300 is exemplary of tracked person-portable object 10 of the first exemplary embodiment of the person-portable object tracking system of the present invention. However, it should be understood that the exemplary security tracking bag 300 as shown is modified according to tracked person-portable objects 110, 210 in alternatives according to the second and third exemplary embodiments. To the extent that reference characters are repeated in FIG. 4, those elements are the same as previously described in detail.

The security tracking bag 300 includes a bottom 310 and a side 320. An enclosure within the security tracking bag 300 is sealed by zipper 322. The zipper 322 has a locking mechanism as is conventional with bank security bags. A pair of handles 324 are provided for carrying the security tracking bag 300. The handles 324 are shown in an up position. The handles 324 are in the up position when the bag 300 is being carried. A bottom surface of the bottom 310 is flat. Thus, the bag 300 tends to stand upright as shown when at rest. When the bag 300 is at rest, the handles 324 are in a down position (not shown).

The side 320 and the bottom 310 are fragmented at a bottom center portion of the bag 300 to expose certain features within the bag 300. Thus, a side 325 opposite the side 320 is visible through the enclosure within the bag 300. A pocket 326 is shown attached to an inner face of the opposite side 325. Thus, the pocket 326 is contained within the enclosure sealed by the zipper 322. In various embodiments, the pocket 326 is either permanently sewn or hot glued, or removably attached to the side 325 by hook and loop fasteners or the like. In addition to the flat bottom 310, the sides 320, 325 are self-supporting. Thus, the bag 300 stands upright as shown even when the enclosure is empty.

The bottom 310 of the bag 300 includes an intermediate cushioning, filling or protective layer, such as a foam layer 330. The foam layer 330 has die cut holes that house the asset tag 12 and the event detection module 14. It is advantageous to house the asset tag 12 and event detection module 14 in this manner because the foam, and additional surrounding structure described below, provide protection to the asset tag 12 and the event detection module 14 from damage due to shock, impact, detachment, crushing, moisture and other hazardous events and environments.

In addition to the flat bottom 310 and the self-supporting sides 320, 325, the weight and rigidity of the foam layer 330 and the components housed within the foam layer 330 also aid the bag 300 in staying upright. However, in the exemplary embodiment, the total weight of the asset tag 12, event detection module 14, and foam layer 330 is but a fraction of the weight of the entire bag 300.

The asset tag further contains antenna 328. The antenna 328 is not shown in FIGS. 1 to 3. However, it should be understood that nearly all of the means of communication described above require an antenna 328 for transmission and reception of information. The antenna 328 is shown in FIG. 4 to illustrate certain design issues associated therewith.

When the bag 300 is being transported in a cluster of other tracked person-portable objects, as previously described, then a tendency may exist for the bag 300 to be packed or loaded during transit in close proximity with other person-portable objects. This proximity may inhibit transmission or reception for the antenna 328 when that antenna 328 is located at the bottom 310 of the bag 300 as shown. Thus, an incentive may exist to orient the antenna 328 in a higher location within the bag 300.

For the foregoing or other reasons of design choice, in an alternative embodiment, the asset tag is located in the pocket 326 rather than in the foam layer 330. It is believed that the best possible location of the antenna for the purposes of transmission and reception integrity is near the top of the bag 300. Thus, in yet another alternative embodiment, the pocket 326 containing the asset tag 12 is located higher up on the side 325 than shown.

Despite the advantages possibly gained in improved reception and transmission quality, several drawbacks are also associated with the embodiments wherein the antenna 328 is located near the top of the bag 300. For example, in many uses, a person handling the bag 300 may have a motivation to frustrate the effective transmission and reception of information to and from the antenna 328. A thief may not want to be caught with the bag 300. A courier may not want performance evaluated through the use of an person-portable object tracking system that tracks the bag 300. In such instances, it is preferred that the asset tag 12, including the antenna 328 be concealed. By concealing the asset tag 12, the fact that the bag 300 is a tracked person-portable object within an person-portable object tracking system might also be concealed.

Therefore, in the preferred embodiment, the asset tag 12 is concealed in the foam layer 330. Thus, in this exemplary embodiment, a top surface of the foam layer 330 is continuous and uninterrupted. The die cut openings housing the asset tag 12 and the event detection module 14 are accessed through a bottom surface of the foam layer 330. Preferably, a bottom extremity of the enclosure is defined by a false bottom covering the top surface of the foam layer 330 inside the bag 300. The asset tag 12 and event detection module 14 are installed, replaced, and repaired either by removing the foam layer 330 from the enclosure through an opening created at the top of the enclosure when the zipper 322 is opened, or by entering through an opening (not shown) in the flat bottom 310. In still further embodiments, the foam layer 330 is enclosed in a plastic or metal case.

In yet another alternative embodiment, the asset tag 12 is provided in the foam layer 330 as shown, and a decoy asset tag is provided in the pocket 326 as described above. Naturally, the decoy asset tag may be provided in any location more readily apparent than the concealed opening(s) in the foam layer 330.

As has been previously described, the event detection module 14 includes event detection sensors 30, 32. Various embodiments of event detection sensors 30, 32 are shown in FIG. 3 and will be described in detail below. As shown, these exemplary event detection sensors are external to the event detection module 14. However, for the purposes of comparison with the schematic of FIG. 1, they should be considered to be included as a part the event detection module 14. Either way, they are clearly included as a part of the tracked person-portable object 10, here the exemplary security tracking bag 300.

There is shown a photocell 332, a patch of smart fiber 334, and a magnetic reed switch 336. Each constitutes and embodiment of an event detection sensor. At the most rudimentary level, an event detector requires a sensor of one description or another to detect an event. Therefore, event detection sensors are also referred to herein interchangeably as event detectors. Each event detector is connected to the event detection module 14 by wires (not shown).

The photocell 332 detects the presence or absence of light. When light is present, the photocell 332 transmits a first logic signal (e.g. high or low) to the signal conditioning electronics 28 or the micro controller 250, depending on the embodiment. When light is absent the photocell 332 transmits a second logic signal, different from the first logic signal. The exemplary embodiment of the security tracking bag 300 includes the micro controller 250 to process the signal generated by the photocell 332. Alternatively, a photo resistor or a photo transistor may be substituted for the photocell 332 as a means of detecting the presence or absence of light and generating a signal representing an applicable state.

The magnetic switch 336 is in an open circuit state when the handles 324 are in a down position. By raising the handles to the up position shown, a closed circuit is formed. The micro controller 250 or signal conditioning electronics 28 identifies the state of the circuit, open or closed, and associates that state with the corresponding position of the handles 324. Alternatively, the states are reversed so that the circuit is closed when the handles 324 are in the down position and open when the handles 324 are in the up position. The states of the photocell 332 are also alternatively reversed. Further, according to design preference, a CMOS low signal is alternatively substituted for an open switch circuit as a state indicator. Even further embodiments substitute a purely mechanical switch or an optical sensor for the magnetic switch 336 as a means of detecting the position of the handles 324.

The zipper 322 includes one of the above described sensors (not shown) that indicates whether the zipper 322 is opened or closed. Thus the state of the zipper 322 indicated by the zipper sensor is indicative of the opened or closed state of the enclosure within the bag 300.

Since the zipper 322 includes a locking mechanism, unauthorized persons might not be able to access the enclosure within the bag 300. Such persons may resort to cutting the sides 320, 325 in order to access the contents. The smart fiber 334 is designed to detect when this takes place. It is a recently developed fiber capable of detecting a tear therein. Alternatives embodiments of this means include wires containing integrity indicating electrical signals and optical fibers containing integrity indicating optical signals, these being either adhered to or woven into the sides 320, 325. Such fibers are in development and use, for example, by the military to detect soldiers' wounds. When a cut is made in the sides 320, 325, a signal is generated indicating a cut state.

Various embodiments also include the following sensors, not shown, for event detection: temperature, humidity, shock, motion, volume, weight, and attitude or positional orientation sensors. These event detection sensors variously take the form of magnetometers, accelerometers, Micro Electro-Mechanical System (MEMS) sensors, scales, and gyroscopes. Thus, the most advanced embodiment of a tracked person-portable object in the person-portable object tracking system of the present invention would have a dozen or more event detectors of various and diverse descriptions.

In yet another embodiment, the bag 300 includes an audible alarm. When a position report is prompted by the occurrence of any event or a particular predetermined event, the audible alarm is sounded. The twofold purpose of this audible alarm is comparable to well known vehicular alarms: to alert bystanders to the possibility or likelihood of unauthorized activity with respect to the person-portable object, and to draw the attention of those within earshot to the person-portable object.

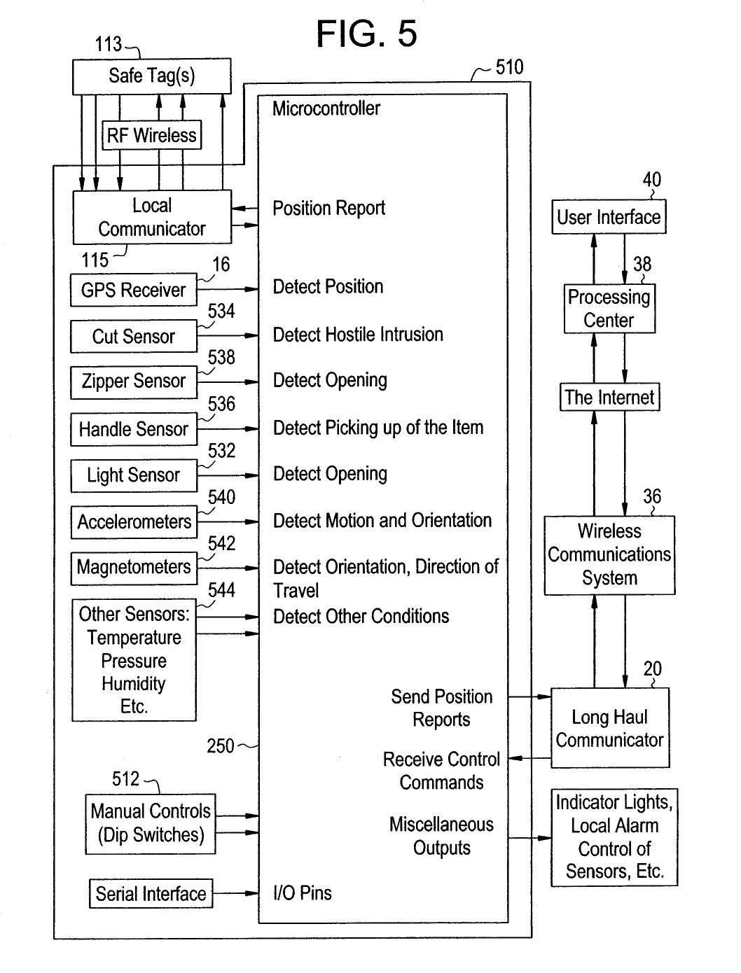

FIG. 5 illustrates a schematic diagram of the overall system that is cooperative with a bag 300 of the type illustrated in FIG. 4, where safe tags 113 in the form of asset tags 14 or the like are in communication by hard wired or wireless links to a communication system 510, via a local communicator 115. The communication system 510 includes a microcontroller 250, having a plurality of input and output ports, including a serial interface 511. Also coupled to the microcontroller 250 are the GPS receiver 16, for providing position information about the tag location, and a variety of sensors, including light sensor 532, cut sensor 534, handle sensor 536 and zipper sensor 538 to detect hostile intrusion, opening or movement of the bag. In addition, accelerometers 540, magnetometers 542 or other environmental sensors 544 as are known in the art, can be used and coupled to provide inputs to the microprocessor 250. Manual controls 512, in the form of DIP switches or the like in a non-limiting example, may be used to activate or deactivate one or more of the sensors. A plurality of ports for external communication with the components already described for data exchange display and indication of relevant events or conditions are also provided.

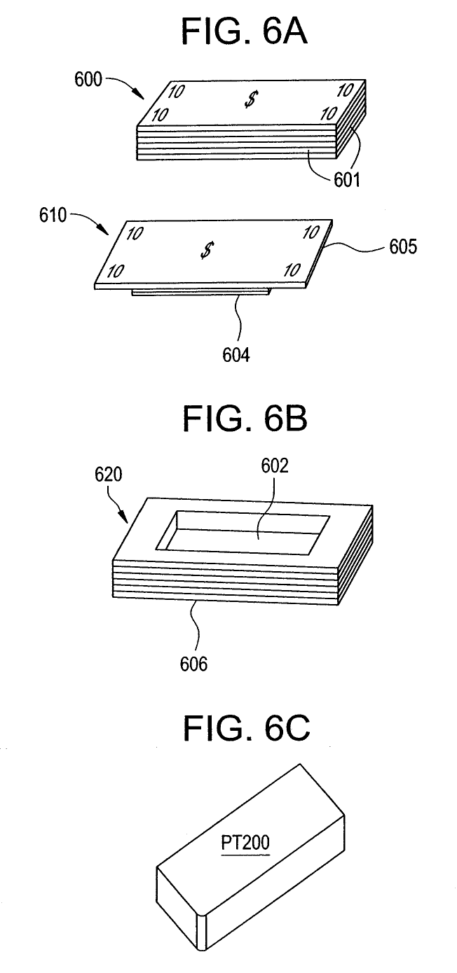

Referring now to FIG. 6A, there is shown an exemplary embodiment of a tracking money pack 600 that comprises a top part 610 and a bottom part 620, as illustrated in FIG. 6B, according to the present invention. The security tracking money pack 600 is another embodiment of a tracked person-portable object 10 of the first exemplary embodiment of the person-portable object tracking system of the present invention. However, it should be understood that the exemplary tracking money pack 600 as shown may be modified according to tracked person-portable objects 110, 210 in alternatives according to the second and third exemplary embodiments. To the extent that reference characters are repeated in FIG. 6, those elements are the same as previously described in detail.

The tracking money pack 600 may be a stack of actual paper currency sheets 601, the stack being die cut to remove a cut portion and form a cavity 603 of sufficient size so that it can contain the tracking device 630, as illustrated in FIG. 6C. The cavity 603 is sealed with a portion of the die cut portion 604, such that the money pack looks and feels authentic. Of course, a tracking money pack may be formed in any of a variety of ways, with real currency only on the outside planar surfaces 605, 606 and the tracking device inbetween. Moreover, any of the activation technologies that have previously been described for the tracker security bag 300 may be used, including an automated or manual actuation switch, proximity switch, vibration detector, light detector or the like. Clearly, the tracking money pack can be placed within any conventional security bag, and used to track the location of that bag.

The money pack unit 630 may comprise a wireless unit manufactured by Sendum (model PT200) having a dimension of 3¼ inches by 1½ inches and ¾ inches. As the normal size of an existing banded money stack is ½ inch in thickness for 50 bills, two packs or bundles of 50 bills would be required to contain the currently available embodiment of unit 630. The current unit is battery powered and has a 21 day life, and would be charged on a periodic basis according to a schedule to ensure readiness.

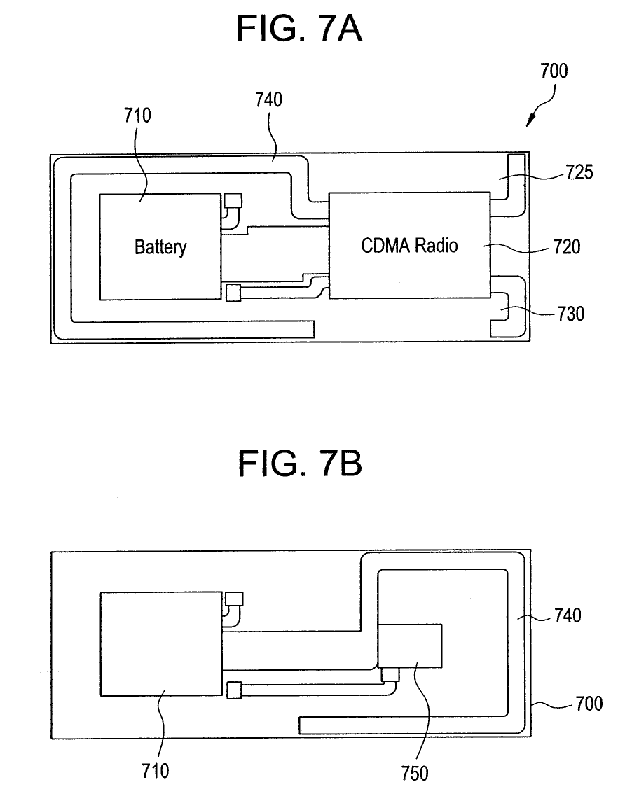

Subsequent generation devices can be made on flexible circuit boards 700 with a size of ¼ inch depth and appropriate width and length, sufficient to carry a battery 710, microprocessor 750, CDMA radio 720 for providing CDMA 725 outputs and GPS Receiver 730. All of the components are coupled by printed circuit conductors 740 in a manner known in the art. A top view of an embodiment of such flexible circuit board is illustrated in FIG. 7A and a bottom view in FIG. 7B. The transmission from the device can be detected, for example by without limitation, by a RF beacon locator (TRX-3S from www.WildlifeMaterials.com), which may be tuned to a specific freq. ex: 219.6 or any other assigned freq. With the locator or wand security/law enforcement personnel can pinpoint the inserted transmitter to within a few feet.

In the field, the money pack, having any current or future circuit design, would be in a stand-by passive mode, possibly sitting in a charging station in a money drawer. At the time of robbery, bank personnel would activate the device with a switch or other automated activation technique using magnetic switch or sensor operation (reed switch or photo-optical sensor, etc.). Tracking would begin by notifying a central unit at a designated authority, such as the police, by calling in a number assigned to the device. The device can then be tracked and located from any web-based internet connected computer.

Other than the exemplary security tracking bag 300 and money pack 600, described above, alternative examples of a tracked person-portable object include shipping boxes, such as those used by express delivery couriers, luggage, suitcases or briefcases. Thus, in alternative embodiments of the tracked person-portable object 10, the elements described above in connection with the security tracking bag 300 are incorporated with a shipping box, luggage, briefcase or the like. Moreover, a broad spectrum of such alternatives become readily apparent as one skilled in the art appreciates the versatility of the flexible circuit board 700 in FIG. 7 and the techniques for tracking a device containing the board as disclosed herein. The board 700 may be simply incorporated into containers or laid in between contents and used for tracking when activated under a variety of circumstances.

The various signals generated by the above described embodiments of the event detectors 30, 32 generally take the form of an electrical signal including the presence or absence of electrical continuity, resistance, or coded pulses. Referring again to FIG. 1, the signal conditioning electronics 28 receives and processes these signals as necessary to create clean inputs for use by the event detection logic 26.

The event detection logic 26 is digital based logic. Thus, in one primitive embodiment, the event detection logic 26 includes a circuit or circuits containing pull-up and pull-down resistors and logic elements such as inverters and AND, NAND, OR, NOR, and XOR gates, and so forth. In the exemplary embodiment, a micro controller 250 runs a program designed to implement the function of any combination of logic gates, or any other function of the information input thereto. Thus, actually implementing logic gates is more limited and basic. If such a limited and basic function is all that is desired, naturally, it may still be implemented by the micro controller 250, which will be described in greater detail below.

In the first exemplary embodiment, the output of the event detection logic 26 is a simple on or off, high or low, logic signal. One of these signals operates as the prompt to initiate a position reading. The other does not. In alternative embodiments, the event detection logic outputs a more complicated signal containing more information in more than one bit.

In a very simple embodiment, the tracked person-portable object 10 includes only one event detection sensor 30. In this embodiment, the event detection logic 26 may simply pass through the properly conditioned signal output by the sensor 30. Thus, in this simplified embodiment, the output of the single sensor 30 may itself constitute the logic that determines whether or not a position report is prompted from the asset tag 12.

In a slightly more complicated embodiment, consider an application designed to minimize false positive indications of an event. In this embodiment, the conditioned outputs of certain event detectors 30, 32 are processed by the event detection logic 26 according to AND logic to indicate a detected event. By logically pairing the outputs of the smart fiber 334 and the photocell 332 in this manner, if the smart fiber 334 indicates a cut, but the photocell 332 does not detect light, then the event detection logic 26 determines that a cut in the sides 320, 325 of the bag 300 is an incidental cut not passing all the way through, a pin hole passing all the way through but of insignificant size, or some other sort of false positive reading from the smart fiber 332. Under these conditions, the micro controller 250 would determine the state of “no event.” In order to make such determinations, the micro controller 250 runs an embedded computer program.

Treating the outputs of the zipper sensor and the photocell 332 with AND logic in a manner similar to that described above also prevents false positive indications of an event by the zipper sensor when the zipper does not properly lock or is left only partially or slightly opened. In this embodiment having only three event sensors, the zipper sensor, the photocell 332 and the smart fiber 334, the result of the AND logic function is further processed according to OR logic within the event detection logic 26. The micro controller 250 outputs a signal indicating the result of the logic program to the asset tag 12 from a designated output pin. Thus, according to that scheme of logic, if either the zipper sensor or the smart fiber 334 detects an event, then a position report is prompted from the asset tag 12, with false positives eliminated.

In an example of AND logic from the second exemplary embodiment, the local communicators 115 additionally operate as event detectors for the event of proximity with the safe tag 113 or lack thereof. Thus, the local communicators 115 output a signal that passes through the signal conditioning electronics 28 to the event detection logic 26. That signal is processed by the micro controller 250 along with the output of magnetic switch 336 associated with the handles 324 according to AND logic. In this example the person-portable object tracking system detects an event when the handles 324 of the security bag 300 are raised and the security bag 300 is beyond the predetermined proximity with the safe tag 113, but does not detect an event if only one of those discrete events occurs. This combination would prevent the unwanted false positive indication of an event when the bag 300 is loaded upside down causing the handles 324 to be in the up position even though the bag is not being carried away.

Expanding upon the above example, the micro controller 250 processes the output of the zipper sensor and the local communicator 115 using AND logic. Thus, opening and closing the enclosure as a routine matter of inserting and removing the contents of the enclosure prior to and after transit in the bag 300 would not indicate an event. Rather, an event would only be indicated when the enclosure is opened beyond proximity with a safe tag 113. The micro controller 250 further processes the result of the AND logic function in its program according to OR logic and outputs a signal indicating the result of the logic program to the asset tag 12. Thus, routine carrying of the bag 300 by its handles 324, or opening of its enclosure, in the proximity of a safe tag 113 will not prompt a position report, but doing so outside the proximity of a safe tag 113 will.

In the above example, if for some reason the bag 300 is carried away from the bottom, with the handles down 324, an event would not be indicated though actually occurring. Thus, false negatives may also occur. It will be a matter of preference and choice how to design the event detection logic 26 to process the information gathered from the event detectors.

Several of the above examples describe a scheme in which the event detection logic 26 is designed to distinguish between authorized and unauthorized occurrences of various events. It is believed that those of skill in the art will recognized that many other logical schemes may be implemented to distinguish between authorized and unauthorized occurrences of other events not discussed in the examples herein.

Referring again to FIG. 3, in this exemplary embodiment, micro controller 250 is substituted for the more elementary circuitry of the event detection logic 26. A bus 248 runs between the micro controllers 250 and the event detection sensors 230 and the local communicators 115 in each tracked person-portable object 210, 211.

The micro controller 250 enables far more sophisticated processing of the outputs of plural event detection sensors 230. Nevertheless, it should be noted that any logic capable of implementation by event detection logic 26 can also be implemented by the micro controller 250 in the form of software programs contained therein.

The micro controllers 250 are programmed to identify varying levels of concern regarding the possibility of an event. For example, when proximity with a safe tag 113 is broken in one embodiment, the micro controller 250 changes to a state of alert. The micro controller 250 then applies logic that takes into account the condition of other event detection sensors 230 and decides whether or not to prompt a position report based on an evaluation of that information.

Further, in one embodiment, an identification means similar to a bar code is included with each safe tag 113. By accessing this identification means, the micro controller 250 identifies whether a proximate safe tag 113 represents a courier, a transport vehicle, a shipping point or a receiving point.

Still further, in an embodiment intended to perform control logic based on the passage of time, the micro controller 250 includes an internal clock. Thus, in an example of the above described logic, when the micro controller 250 identifies that the only proximate safe tag 113 represents a courier, and suddenly, in a very short amount of time, all tracked person-portable objects 210, 211 exceed the predetermined proximity with the safe tag. Then, the micro controller 250 is programmed to conclude that the courier probably walked away from the tracked person-portable objects 210, 211. In this instance, the micro controller 250 would designate a heightened state of alert corresponding to this conclusion and begin counting time. If the safe tag 113 is reacquired in less than a predetermined amount of time corresponding to this particular heightened state of alert and all tracked person-portable objects 210, 211 are present and accounted for, then the micro controller 250 would return to the prior state having a lower alert status. If, on the other hand, the predetermined amount of is time corresponding to the heightened state of alert indicating that a courier has walked away is exceeded, then the micro controllers 250 prompt a position report.

Still further examples of varying levels of alert status included in various embodiments of the micro controller 250 relate to the use of the tracked person-portable objects 210, 211 during times of dormancy. For example, when the tracked person-portable object 210, 211 is a security bag 300, there are times when the bag 300 is not is use. At such times, the bag 300 does not contain any valuables, and it may not be in transit from one point to another. The embodiment of the micro controller 250 designed to capitalize on such times of disuse includes various states indicating such dormancy. For example, when a dormant state is indicated, the micro controller 250 sends a signal to the long haul communicator 20 activating a power off or power save feature of the long haul communicator 20. When the bag 300 reenters an active time of use, the micro controller 250 moves to a corresponding state of alert above dormancy and powers on and up the long haul communicator 20.

Depending on the sophistication of the event detection sensors 230 included with the tracked person-portable objects 210, 211, an embodiment employing logic circuitry and/or logic chips in lieu of the micro controller 250 may or may not be able to recognize all of the various states of alert desired. Thus, in an embodiment designed for applications where it is known or believed that situations will occur wherein the event detection logic 26 is not able to recognize a particular state based solely on the inputs of event detection sensors 30, 32, then an external DIP switch 512 (see FIG. 5) or other manual control is provided. Furthermore when used in conjunction with a micro controller 250 as shown in FIG. 5, the manual controls such as DIP switches 512 provide a convenient mechanism for setting modes of operation of the electronics, particularly the micro controller 250.

The settings of variously toggled DIP switches 512 are input to the micro controller 250 or event detection module 14 and have various meanings to the micro controller 250 or event detection module 14. For example, one such setting instructs the micro controller 250 or the event detection module 14 to ignore the DIP switch. Other settings correspond to various states.

In order to externally inform the micro controller 250 or event detection logic 26 of a particular state condition, the DIP switches are changed to a particular predetermined setting corresponding to and indicating that state. In another embodiment, this external setting of a state indication is performed remotely through the user interface 40 and communicated to the micro controller 250 or the event detection module 14 through the wireless communications system 36. In yet another embodiment, the above described control is achieved through the use of a flash memory chip (not shown). In still yet another embodiment indicative of the flexibility available with a micro controller 250, certain ones of the event detectors 230 are given higher levels of importance than certain other ones in determining the state of alert recognized by the micro controller 250.

When the micro controller 250 initiates a position report or other transfer of information over the wireless communications system 36, the micro controller 250 does so through an output pin connected to an input of the local communicator 115. The local communicator 115 in turn relays that prompt from the micro controller 250 to the long haul communicator 20 through the central local communicator 113.

It should be noted that, in one instance of the first exemplary embodiment of the person-portable object tracking system, all of the information provided to the micro controller 250, as described above, is communicated to the processing center 38 through the wireless communications network 36; all of the control functions performed by the micro controller 250 are performed by the processing center 38; and, all of the outputs of the micro controller 250 are communicated to the asset tag 12 by the processing center 38 through the wireless communications network 36. However, this embodiment requires the initiation of additional communications by the long haul communicator 20, thus increasing costs and decreasing effective life of system components. Further, the speed with which the system processes and responds to event information is significantly reduced.

In yet another alternative embodiment, it should be noted that many advanced functions of the micro processor 250 are capable of implementation by components in the event detection logic 26. However, depending on the complexity, such a logic circuit may or may not be practical.

In one embodiment, the processing center 38 is a personal computer and the user interface 40 includes a standard computer monitor, keyboard and mouse. Regardless of the particular embodiment of the processing center 38 and the user interface 40, it is preferred that a security mechanism prevent unauthorized access to the processing center 38 and/or, in the embodiment where a web based interface over the Internet is incorporated, to that interface. For example, a security password is required to access the processing center 38 and/or an Internet web site in various embodiments.

The user interface may be designed in any of a variety of ways to display or otherwise present to a user the information relevant to the monitoring or tracking of objects within a geographical area of interest. The interface may have maps of the geographical area (global, national or local) and may have listings of assets with ID numbers or descriptors as well as their locations within the relevant geographical area. The listing may contain an indication of their status and provide alarm or other exceptional event indicators to alert or inform an operator of system status information or developments. The interface may also provide phone numbers or automated email links to individuals or organizations that must be contacted. The development of such interface is well within the knowledge and capability of one of ordinary skill in the art.

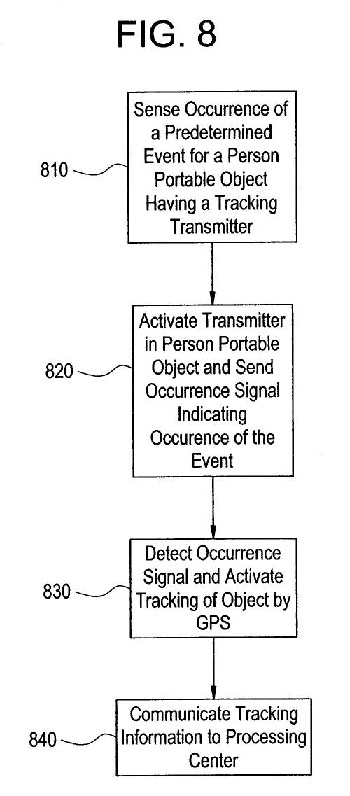

Turning next to the methods in which a person portable object may be tracked using the novel structure of the present invention, an exemplary illustration of a sequence of steps is illustrated in FIG. 8. In a first step 810, the occurrence of a predetermined event, such as the detection of an unauthorized removal or opening of a money bag 300 by a detector, or the activation by a bank teller of a switch in a wireless event detection unit embedded in a money pack 600. In a next step 820, the transmitter in the person portable object is activated and a signal sent indicating the occurrence of an event. Then, in step 830, the occurrence signal transmitted by the device in the person portable object is detected and tracking is initiated by GPS or similar tracking system. Then, in step 840, the tracking information is obtained and communicated to a central tracking center, such as a police station, for analysis, using mapping and tracking software, and identification of the object location. Authorities having internet connected PC's in their vehicles could readily follow the object as it is moved and eventually find and retrieve the object.

Although certain exemplary embodiments of the present invention have been described, the spirit and scope of the invention is by no means restricted to that which is described above. For example, in an alternative embodiment diverging from the above described embodiments, the tracked person-portable objects 10 are units worn by children at play in an amusement park, and the processing center 38 is a hand held portable device in the possession of a parent or other person responsible for supervising the tracked children. Thus, the invention encompasses any and all embodiments within the scope of the following claims.

What is claimed is:

1. A person-portable object tracking system comprising:
a tracked person-portable object, said object being transportable by a person from one location to another location;
a location identifier disposed proximate to said tracked person portable object for providing current location information indicating a current location of said tracked person-portable object;
a central processor for processing the current location information for said tracked person-portable object; and
a communicator operative to communicate said current location information to said central processor.

2. An person-portable object tracking system as set forth in claim 1, further comprising an event detector disposed proximate to said tracked person portable object for detecting a predetermined event and providing information about said event to the communicator, wherein said communicator is operative to send at least one signal to the central processor indicating the occurrence of said event.

3. A person-portable object tracking system as set forth in claim 2, wherein said event comprises at least one of: impact above a predetermined threshold, exposure of a predetermined position to light, opening an enclosure, motion, cutting, lifting a handle, and proximity beyond a predetermined distance from a predetermined location.

4. An person-portable object tracking system as set forth in claim 1, further comprising a plurality of event detectors, each disposed proximate to said tracked person-portable object for detecting the occurrence of a plurality of predetermined events and providing information about said event to the communicator, wherein said communicator is operative to send at least one signal to the central processor indicating the occurrence of at least one of said plurality of events.

5. A person-portable object tracking system as set forth in claim 4, wherein the central processor determines the occurrence of an event only when a predetermined group of said plurality of event detectors detect the occurrence of selected ones of said plurality of events.

6. An person-portable object tracking system as set forth in claim 2 wherein the central processor determines the occurrence of an event only when said event detector detects the occurrence of an event at a predetermined time.

7. A person-portable object tracking system as set forth in claim 1, wherein said tracked person-portable object is one of a security transport bag and a money pack.

8. A person-portable object tracking system as set forth in claim 1, wherein said location identifier is operative to use global positioning satellite system information and said communicator is at least one of a cellular telephone, pager and freenet device.

9. A person-portable object tracking system as set forth in claim 1, wherein said location identifier includes a radio frequency identification tag.

10. A person-portable object tracking system as set forth in claim 1 wherein said central processor is operative to archive a history of locations of said tracked person-portable object.

11. A person-portable object tracking system comprising:
a safe tag outputting a safety signal;
a plurality of at least two tracked person-portable objects, said tracked person-portable objects each including a local communicator for receiving said safety signal;
a location identifier for identifying a location of said safe tag;
a central processor for processing the location of said safe tag; and
a communicator for communicating said location to said central processor.

12. An person-portable object tracking system as set forth in claim 11, further comprising an event detector for detecting at least one predetermined event and providing information about said event to the communicator, wherein said communicator sends a signal to the central processor indicating the occurrence of said event.

13. A person-portable object tracking system as set forth in claim 11, wherein said location identifier is operative to use global positioning satellite system information and said communicator is at least one of a cellular phone, pager and freenet communication device.

14. A person-portable object tracking system as set forth in claim 11, wherein said central processor is operative to archive a history of locations of said safe tag.

15. A security tracking bag comprising:
a bottom portion;
a side portion; and
an asset tag having a predetermined location, said asset tag being operative to remotely identify said location.

16. The security tracking bag as set forth in claim 15, wherein said asset tag is contained in said side portion.

17. The security tracking bag as set forth in claim 15, wherein said asset tag is contained in said bottom portion.

18. The security tracking bag as set forth in claim 17, wherein said bottom portion includes a padded portion and said asset tag is concealed in a compartment in said padded portion.

19. The security tracking bag as set forth in claim 18, further comprising a decoy asset tag.

20. The security tracking bag as set forth in claim 16, wherein said asset tag is contained in said side portion by a sleeve.

21. The security tracking bag as set forth in claim 16, wherein said asset tag is contained in said side portion by a pocket.

22. The security tracking bag as set forth in claim 21, wherein said pocket is removably attached to said side portion by hook and loop fasteners.

23. The security tracking bag as set forth in claim 21, wherein said pocket is permanently sewn into said side portion.

24. The security tracking bag as set forth in claim 21, wherein said pocket is hot glued into said side portion.

25. The security tracking bag as set forth in claim 15, further comprising an event detector for detecting a predetermined event and outputting a signal indicating the occurrence of the event.

26. The security tracking bag as set forth in claim 25, wherein said event detector is a photocell and said event is a change from darkness to light.

27. The security tracking bag as set forth in claim 25, further comprising a pair of handles having a down position and an up position and wherein said event detector is a position sensor and said event is when said pair of handles moves from said down position to said up position.

28. The security tracking bag as set forth in claim 25, wherein said event detector is a smart fiber within said side and said event is cut into said side portion.

29. The security tracking bag as set forth in claim 25, wherein said event detector is a motion sensor and said event is motion.

30. The security tracking bag as set forth in claim 25, further comprising an opening having a means of closure, and wherein said event detector detects an act of opening said means of closure.

31. A tracking money pack comprising:
a money pack having a cavity;
a plug for said cavity; and
an asset tag having a predetermined location, said asset tag being operative to remotely identify said location.

32. The tracking money pack as set forth in claim 31, wherein said money pack comprises currency that is legal tender.

33. The tracking money pack as set forth in claim 31, wherein said money pack cavity is formed of a die cut portion.

34. A method of tracking a person-portable object, comprising:
sensing the occurrence of a predetermined event by an event detector;
sending a signal indicating the occurrence of the event from the event detector to a communicator;
prompting a location identifier to identify a location of a tracked person-portable object in response to said event indicating signal; and
communicating said location from said communicator to a processing center through a wireless communications network.

35. A method of tracking a person-portable object, comprising:
sensing a lack of proximity between a tracked person-portable object and a central local communicator in a local system;
prompting a location identifier to identify a location of said tracked person-portable object upon sensing said lack of proximity;
conveying data information identifying said location to a communicator in said local system; and
communicating said location from said communicator to a processing center through a wireless communications network.

36. A method of tracking a person-portable object, as recited in claim 35, wherein said location identifier is an RF receiver and said communicator is operative to communicate with said receiver via RF signals.
